(19) United States
(12) Patent Application Publication
(10) Pub. No.: US 2014/0242351 A1
(43) Pub. Date: Aug. 28, 2014

(54) METHOD FOR LASER MARKING AND RESIN PRODUCT

(71) Applicant: DENSO CORPORATION, Kariya-city (JP)

(72) Inventor: Jun Ohnishi, Mizuho-city (JP)

(73) Assignee: DENSO CORPORATION, Kariya-city (JP)

(21) Appl. No.: 14/182,466

(22) Filed: Feb. 18, 2014

(30) Foreign Application Priority Data
Feb. 26, 2013 (JP) 2013-035803

(51) Int. Cl. B41M 5/26; B32B 5/18

(52) U.S. Cl. CPC B41M 5/267; B32B 5/18
USPC 428/195.1; 427/555

(57) ABSTRACT

The present disclosure relates to a method for laser marking an object. In the method, a coating material is applied on a surface of a predetermined part of the object made of resin so as to provide a coated region on the object. The coated region is different in color from the object. Subsequently, laser is emitted onto a part of the coated region to remove the coating material from the object so as to provide a non-coated region having a predetermined shape within the coated region on the object. Moreover, the laser is emitted to the non-coated region to change a color of a resin surface of the object in the non-coated region. Accordingly, the laser marking can be performed at low cost and high speed without requiring a special device.

### CROSS REFERENCE TO RELATED APPLICATION

This application is based on and incorporates herein by reference Japanese Patent Application No. 2013-035803 filed on Feb. 26, 2013.

### TECHNICAL FIELD

The present disclosure relates to a method for making a marking such as a letter, a graphic or a symbol by laser irradiation, and to a resin product having a marking.

### BACKGROUND

Conventionally, there is a method for laser marking, for example in patent document 1 (JP 2008-155471 A corresponding to US 2008/0152859 A1), in which a pattern of a letter, a symbol, a graphic or the like is provided on an object as following. A coating material is put on a surface of the object, and then the coating material in a predetermined region is removed by laser irradiation.

In Patent Document 1, a coating layer is formed on a surface of a molded product (object to be marked) made of resin by applying a coating material brighter than the molded product. Subsequently, a predetermined part of the coating layer is removed by laser irradiation, and a surface of the molded product is exposed. Accordingly, a pattern of a letter, a symbol or a graphic is traced.

When a white coating material is put on a black surface of the object, a black dirt may adhere to a surface of the white coating material, or the white coating material may be partially removed after removal of a predetermined part of the coating material by laser irradiation and tracing of a pattern of a letter or the like. Accordingly, the pattern of the letter or the like may become unrecognizable.

### SUMMARY

It is an objective of the present disclosure to provide a method for laser marking capable of providing a recognizable marking on an object even when a dirt adheres to the object or a coating material is removed partially from the object, and to provide a resin product having such a marking.

According to an aspect of the present disclosure, a method for laser marking an object is disclosed. In the method, a coating material is applied on a surface of a predetermined part of the object made of resin so as to provide a coated region on the object. The coated region is different in color from the object. Additionally, a laser is emitted onto a part of the coated region to remove the coating material from the object so as to provide a non-coated region having a predetermined shape within the coated region on the object, and to change a color of a resin surface of the object in the non-coated region.

According to the laser marking method, a predetermined pattern can be marked on a surface of the object by a simple procedure including two processes: (i) application of the coating material and (ii) emission of the laser. Since these processes can be performed by using an application device and a laser device which are widely used, marking can be performed at low cast and high speed without requiring a special device.

According to another aspect of the present disclosure, a resin product has a marking, and the marking includes at least one of a letter, a numeric number, a graphic or a symbol. The resin product includes a marking portion, a coating portion and a foam portion. The marking portion is made of resin, and the coating portion is provided on the marking portion. The coating portion has a coating material applied on a surface of a predetermined part of the marking portion, and the coating portion is different in color from the marking portion. The foam portion is provided on the marking portion without overlapping with the coating portion. The foam portion has a foamed resin that is the same as the marking portion in material. The coating portion and the foam portion provide the marking on the marking portion by contrast in color between the coating portion and the foam portion.

Accordingly, the marking such as a letter, a numeric number, a graphic or a symbol, can be shown by the contrast between the coating portion and the foam portion. Because the color of the surface of the marking portion is different from the color of the coating portion, the marking is easily recognizable. Moreover, the foam portion is difficult to be dirtied. Thus, even when a dirt such as oil adheres to the surface of the coating portion, the marking is recognizable. Additionally, the foam portion cannot be separated from the marking portion. Hence, visibility of the marking shown by the foam portion can be kept.

### BRIEF DESCRIPTION OF THE DRAWINGS

The disclosure, together with additional objectives; features and advantages thereof, will be best understood from the following description, the appended claims and the accompanying drawings, in which:

FIG. 1A is a diagram showing an initial state of a resin casing in processes of a laser marking method according an exemplar embodiment of the present disclosure;

FIG. 1B is a diagram showing a state of the resin casing after application of a coating material and before laser emission in the laser marking method according to the exemplar embodiment;

FIG. 1C is a diagram showing a state of the resin casing after the laser emission and completion of the laser marking method according to the exemplar embodiment;

FIG. 1D is a flowchart showing the processes of the laser marking method according to the exemplar embodiment;

FIG. 2 is a schematic diagram showing a lateral side of the resin casing irradiated with a laser at a process of emitting laser in the laser marking method according to the exemplar embodiment;

FIG. 3 is a schematic diagram showing the lateral side of the resin casing including a foamed region after the laser emission, according to the exemplar embodiment; and

FIG. 4 is a diagram showing a resin casing after laser emission of a laser marking method according to a modification example of the exemplar embodiment.

### DETAILED DESCRIPTION

An exemplar embodiment of a method for laser marking and a resin product of the present disclosure will be described hereinafter referring to drawings. In the present embodiment, the laser marking method of the present disclosure is adopted when an identification marking is provided on a sensor used for an airbag of a vehicle.

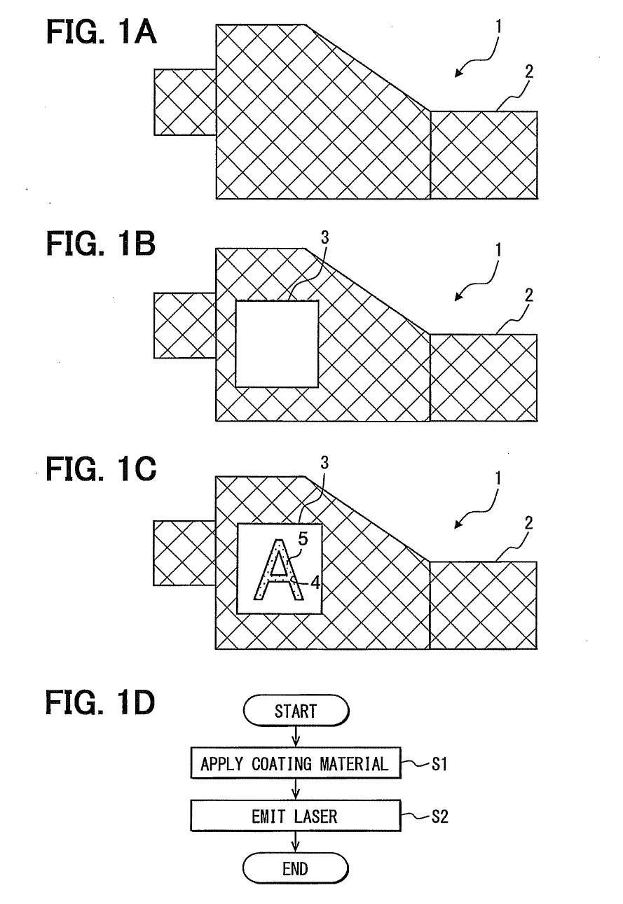

In the present embodiment, as shown in FIGS. 1A to 1C, a marking of a letter “A” is provided as an identification marking on a resin casing 2 of an airbag sensor 1 (resin product). The identification marking is used for distinction from other various components when the airbag sensor 1 is attached to the vehicle. Alternatively, the marking may be an arbitrary letter, an arbitrary numeric number, an arbitrary graphic, or an arbitrary symbol, such as a product number.

The airbag sensor 1 is used for detecting impact when a collision accident of the vehicle occurs, for example. The airbag sensor 1 includes the resin casing 2 (an object to be marked, a marking portion) made of resin, and a non-shown sensor device housed in the resin casing 2. The resin casing 2 has a box shape with black surface. The resin casing 2 is made of polybutylene terephthalate (PBT), for example.

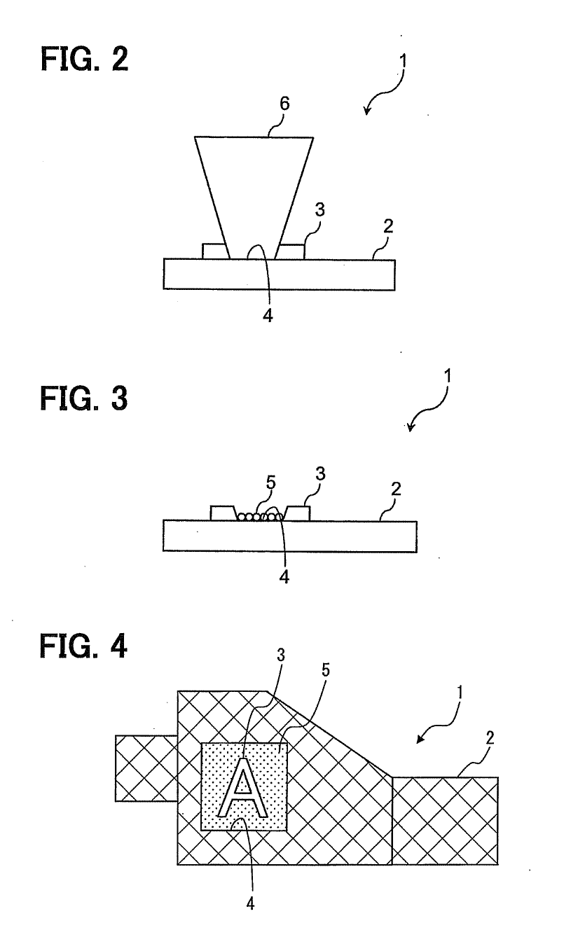

As shown in FIG. 1D, the laser marking method of the present embodiment includes an application process at step S1 and a laser emission process at step S2. As shown in FIG. 1A, a coating material is not applied to the surface of the resin casing 2 in an initial state of the airbag sensor 1. Firstly, in the application process of the airbag sensor 1, a coated region 3 (coating portion) is formed by applying a coating material to a surface of a predetermined part of the resin casing 2 at step S1. The coating material is different in color from the surface of the resin casing 2. In the present embodiment, the coating material is white, for example. When the application process at step S1 is completed, as shown in FIG. 2B, the coated region 3 having a rectangular shape is formed on the surface of the resin casing 2. The coated region 3 is larger than a non-coated region 4 and a foamed region 5 described below, and the coated region 3 thereby includes the non-coated region 4 and the foamed region 5.

The white coating material contains acrylic resin or titanium dioxide as an ingredient, for example. A known ink-jet application device is used for applying the coating material. The coating material is applied to the predetermined part of the resin casing 2 twice in order to avoid uneven application. Alternatively, another method may be adopted, which is capable of forming the coated region 3 on the predetermined part without separation of the coated region 3 from the resin casing 2.

The color of the coating material may have contrast with the color of the resin casing 2 and high visibility. For example, a red-colored coating material may be used with respect to the resin casing 2 having the black surface. The color of the coating material may be changed depending on the color of the surface of the resin casing 2. For example, a black coating material may be applied to the resin casing 2 when the resin casing 2 has a yellow surface. A color difference (dE*) between the surface of the resin casing 2 and the coated region 3 may be larger than or equal to 3 (dE*>=3).

Next, the laser emission process is performed at step S2. In the laser emission process at step S2, laser marking is performed by exposing the coated region 3 to laser light 6. As shown in FIG. 2, a part of the coated region 3 is irradiated with the laser light 6 from above such that a predetermined pattern is traced on the coated region 3. The laser light 6 causes the coated region 3 to burn and be removed in the predetermined pattern. Accordingly, the surface of the resin casing 2 located under the coated region 3 is exposed by the laser light 6 so as to provide the non-coated region 4. Subsequently, the non-coated region 4 is irradiated with the laser light 6, and a resin surface of the non-coated region 4 thereby changes in state. In this state change, the resin surface of the non-coated region 4 is changed in color and is foamed. Accordingly, as shown in FIG. 3, the foamed region 5 in a foamed state is provided on a part of the coated region 3.

The surface of the foamed region 5 (foam portion) has a color different from both the color of the surface of the resin casing 2 and the color of the surface of the coated region 3. In this case, the color of the surface of the foamed region 5 is gray, for example. The change in color and the foamed state of the foamed region 5 is controllable by changing power or types of laser light 6 arbitrarily.

When the laser emission process at step S2 is completed, as shown in FIG. 1C, the white coated region 3 and the gray foamed region 5 are provided on the black surface of the resin casing 2. As a result, a marking of a letter “A” is shown by the foamed region 5 on the airbag sensor 1 as an identification marking, and the marking on the airbag sensor 1 is completed. In this laser marking method, the predetermined pattern such as a letter is set in a laser marker in advance.

The laser light 6 shown in FIG. 2 is radiated from the non-shown known laser marker. The laser marker includes a laser generator, a mirror, a driver, a controller and an operation portion. The laser generator produces and emits laser light 6. The mirror reflects the laser light 6 produced by the laser generator and irradiates the resin casing 2 with the laser light 6. The driver translates or rotates the mirror such that the predetermined part of the resin casing 2 is irradiated with the laser light 6. The controller controls an operation of the driver. The operation portion is used for inputting a control signal to control the controller.

The laser light 6 generated by the laser generator may be ytterbium fiber laser, for example. When the laser light 6 is emitted, the power and moving speed (scan speed) of the laser light 6 have a condition. Thus, the laser marking is performed at appropriate power and scan speed.

As described above, the laser marking method of the present disclosure includes the application process, shown by step S1 in FIG. 1D, in which the coated region 3 is formed by applying the white coating material on the surface of the predetermined part of the resin casing 2 (object to be marked) made of black resin. The white coating material is different in color from the surface of the resin casing 2. The laser marking method further includes the laser emission process, shown by step S2 in FIG. 1D, in which the non-coated region 4 is formed by removing the coated region 3 so as to have a predetermined shape, and the foamed region 5 in a foamed state is formed by changing in color and foaming the resin surface of the non-coated region 4.

According to the above-described laser marking method, a predetermined marking can be proved on the surface of the resin casing 2 by a simple procedure consisting of the application process (S1) and the laser emission process (S2). Moreover, these processes can be performed by using an application device and a laser marker that are used widely. Therefore, marking can be performed at high speed and low cost without using a special device.

Since the laser marking is performed directly on the surface of the resin casing 2, there is no need to put a seal, on which an identification symbol is described, on the surface of the resin casing 2. Therefore, cost can be reduced.

The airbag sensor 1 (resin product) marked by the laser marking method of the present disclosure includes the resin casing 2 (marking portion) made of resin, and the coated region 3 (coating portion) having the white coating material applied on the surface of the predetermined part of the black resin casing 2. The coating material is different in color from the surface of the resin casing 2. The airbag sensor 1 further includes the foamed region 5 (foam portion) that is provided on the resin casing 2 without overlapping with the coated region 3. The foamed region 5 has a foamed resin that is the same as the resin casing 2 in material and is integrated with the resin casing 2. Contrast in color between the coated region 3 and, the foamed region 5 provides a marking that includes at least one of a letter, a numeric number, a graphic or a symbol. The non-coated region 4 and the foamed region 5 have the shape of the marking.

Accordingly, an arbitral pattern of a letter, a numeric number, a graphic or a symbol can be shown on the resin casing 2 by providing the non-coated region 4 and the foamed region 5 having arbitral shapes. Furthermore, the color of the resin casing 2 is different from both the color of the coated region 3 and the color of the foamed region 5, and the coated region 3 and the foamed region 5 are also different from each other in color. Accordingly, the marking can be made to be more easily recognizable due to the contrast or difference in color.

In the present embodiment, the white coated region 3 is provided on the surface of the black resin casing 2, and the non-coated region 4 and the foamed region 5 are provided in a part of the coated region 3 at a predetermined pattern. Even when the airbag sensor 1 is assembled in a dark place, the identification marking can be recognized easily due to the existence of the coated region 3 having the white coating material superior in visibility and brightness.

Even when a dirt adheres to the surface of the coated region 3, or even when the coating material of the coated region 3 is removed, the marking having the predetermined pattern can be recognized due to the existence of the foamed region 5 where the surface of the resin casing 2 is changed in state to be foamed. Accordingly, the predetermined-patterned marking is prevented from being unrecognizable. For example, when the airbag sensor 1 is disposed in the vehicle, a black dirt such as oil may adhere to the surface of the resin casing 2. In this case, the white coated region 3 may become black due to the dirt adhesion and may become unrecognizable. However, the foamed region 5 is in the foamed state, and thus a dirt such as oil is difficult to adhere to the foamed region 5. Therefore, contrast in color between the surface of the resin casing 2 and the foamed region 5 is kept, and visibility of the marking can be maintained.

In the foamed region 5, a surface of resin is changed in state into a foamed state. Thus, even if the coating material in the coated region 3 is removed at the time of assembling the airbag sensor 1 to the vehicle, the marking having a predetermined pattern is recognizable due to the existence of the foamed region 5 without removing and vanishing.

The present disclosure is not limited to the above-described embodiment and can be modified or changed without departing from the scope of the present disclosure. For example, in the above-described embodiment, the non-coated region 4 and the foamed region 5 are provided by removing the coating material along the predetermined pattern that is the shape of the identification marking, after forming of the coated region 3. Alternatively, as shown in FIG. 4, the non-coated region 4 and the foamed region 5 may be provided such that the marking such as letter is highlighted. In other words, the non-coated region 4 and the foamed region 5 may be provided by emitting laser onto a part of the coated region 3 other than the identification marking and removing the coating material except for the part of the identification marking. In this case, the coated region 3 has the shape of the marking of the letter. Also in this case, effects similar to the effects of the above-described embodiment can be obtained.

The coated region 3 may be provided by applying a coating material on a different-colored primer coating on the surface of the resin casing 2. In this case, the laser marking is performed by removing both the coating material of the primer coating and the coating material of the coated region 3 so as to obtain a non-coated region having a predetermined shape.

In the above-described embodiment, the laser marking method of the present disclosure is applied to the marking on the airbag sensor 1. Alternatively, the laser marking method of the present disclosure may be applied to marking on another electronic product. The laser marking method of the present disclosure can be applied to marking of a letter, a numeric number, a graphic or a symbol on a surface of various resin products.

The material of the resin product, for which the laser marking method of the present disclosure is used, is not limited to PBT. A variety of resins such as polyphenylene sulfide (PPS), polyamide (PA), or acrylonitrile butadiene styrene resin (ABS resin) may be used the material of the resin product.

In the above-described embodiment, ytterbium fiber laser is used as the laser light. Alternatively, carbon dioxide laser (CO₂ laser) or excimer laser may be used as the laser light.

In the above-described embodiment, the coating material contains acrylic resin and titanium dioxide as an ingredient. However, various other coating materials may be used as the coating material of the coated region 3.

Additional advantages and modifications will readily occur to those skilled in the art. The disclosure in its broader terms is therefore not limited to the specific details, representative apparatus, and illustrative examples shown and described.

What is claimed is:

1. A method for laser marking an object, the method comprising:
applying a coating material on a surface of a predetermined part of the object made of resin so as to provide a coated region on the object, the coated region being different in color from the object; and
emitting a laser onto a part of the coated region to remove the coating material from the object so as to provide a non-coated region having a predetermined shape within the coated region on the object, and to change a color of a resin surface of the object in the non-coated region.

2. The method according to claim 1, wherein the emitting of the laser includes foaming of the resin surface of the object in the non-coated region to change the color of the resin surface of the object in the non-coated region.

3. The method according to claim 1, wherein
the non-coated region has a shape of a marking, the marking including at least one of a letter, a numeric number, a graphic or a symbol, and
the coated region encloses the non-coated region.

4. The method according to claim 1, wherein
the coated region has a shape of a marking, the marking including at least one of a letter, a numeric number, a graphic or a symbol, and
the non-coated region encloses the coated region.

5. The method according to claim 1, wherein
the coated region is different in color from the resin surface of the object in the non-coated region changed in color, and
the coated region and the resin surface of the object in the non-coated region provide a marking by contrast in color between the coated region and the resin surface of the object in the non-coated region, the marking including at least one of a letter, a numeric number, a graphic or a symbol.

6. A resin product having the marking obtained by the method according to claim 1.

7. A resin product having a marking, the marking including at least one of a letter, a numeric number, a graphic or a symbol, the resin product comprising:
a marking portion made of resin;
a coating portion provided on the marking portion, the coating portion having a coating material applied on a surface of a predetermined part of the marking portion, the coating portion being different in color from the marking portion; and
a foam portion provided on the marking portion without overlapping with the coating portion, the foam portion having a foamed resin that is the same as the marking portion in material, wherein
the coating portion and the foam portion provide the marking on the marking portion by contrast in color between the coating portion and the foam portion.

8. The resin product according to claim 7, wherein
the foam portion has the shape of the marking, the marking including at least one of a letter, a numeric number, a graphic or a symbol, and
the coating portion encloses the foam portion on the marking portion.

9. The resin product according to claim 7, wherein
the coating portion has the shape of the marking, the marking including at least one of a letter, a numeric number, a graphic or a symbol, and
the foam portion encloses the coating portion on the marking portion.
